(19) United States
(12) Patent Application Publication
(10) Pub. No.: US 2013/0339515 A1
(43) Pub. Date: Dec. 19, 2013

(54) NETWORK SERVICE FUNCTIONALITY MONITOR AND CONTROLLER

(71) Applicant: Rajesh Radhakrishnan, Reston, VA (US)

(72) Inventor: Rajesh Radhakrishnan, Reston, VA (US)

(73) Assignee: International Business Machines Corporation, Armonk, NY (US)

(21) Appl. No.: 13/495,640

(22) Filed: Jun. 13, 2012

(51) Int. Cl. G06F 15/173

(52) U.S. Cl. 709/224

(57) ABSTRACT

A system and method is disclosed for controlling functionality of a computer network to avoid occurrence of resource or service incidents that degrade or disrupt operation of the network. The metrics monitored are formulated into control charts. Nelson like rules analyze the control charts to identify abnormal service events and abnormal resource events. The identified abnormal service events and abnormal resource events are analyzed using various analytic modes to identify potential resource incidents and potential service incidents. The analytic modes include covariate analysis, multivariate analysis, time series analysis and similar analytic techniques. Information on the abnormal service and abnormal resource events and the information on the potential service incidents/potential resource incidents are forwarded to a control or decision center to guide actions by an autonomic system or human operator to prevent the identified potential resource incidents and potential service incidents from degrading or disrupting operation of the network.

### TECHNICAL FIELD

The present invention relates to monitoring and managing a computer network, more particularly it relates to a method and system for monitoring the functionality of the network and generating information on which to base proactive action to prevent service or resource incidents from inhibiting or interrupting the operation of the network.

### BACKGROUND

Current computing environments, such as a complex distributed environments and cloud service environments, rely on many elements, components, and factors to provide service and functionality to those that use them. Examples of such systems are a financial institution's ATM system and on-line access to customer financial information and accounts, e-commerce platforms, and the complex distributed systems of businesses and corporations, from small to large business and corporations. Incidents causing degradation and/or interruption of service to users and customers can cause significant financial loss and outright havoc.

Many distributed or cloud network systems typically have means to detect service and resource incidents. However, most of these means are reactive to resource and service incidents and not proactive, in that action is not taken until the incident occurs. The advantage of such systems is their ability to quickly identify the source of the cause of the incident after it has occurred and thus limit the effect of the degradation or interruption of service caused by the incident. Those systems that do try to provide some predictive capacity with respect to the potential for the occurrence of an incident generally only look at percent utilization of different elements of the system or whether the function is breaking a specific threshold. None of these systems are truly proactive in trying to predict or identify potential resource or service incidents on a consistent effective and network wide basis. Therefore, there is a need for a truly proactive system or method for predicting or identifying potential resource incidents and potential service incidents on a consistent and effective network wide basis.

### BRIEF SUMMARY

A method for controlling service functionality in a distributed network includes monitoring metrics of a plurality of network factors, formulating a control chart for each metric monitored of the network factors, detecting abnormal events by applying Nelson like rules to the control charts, predicting if an abnormal event indicates a potential incident by analyzing the abnormal events with a predetermined analytic mode, and sending information regarding detected abnormal events and potential incidents to a control center to thereby aid in controlling service functionality of the distributed network. In a further aspect of the invention, it determines if an abnormal event is an abnormal resource event or an abnormal service event. In another aspect of the invention, it determines if a potential incident is a potential resource incident or a potential service incident. In another aspect of the invention, analyzing with a predetermined analytic mode includes analyzing by one or more of the following analytic modes: correlation analysis of abnormal events detected using Nelson Rules wherein the abnormal events are used as variables in the analysis, multivariate analysis, and time series analysis of control chart data.

In another variation of the method of the invention, one or more detected abnormal resource events are used as independent variables and one or more abnormal service level events are used as a dependent variable in a multivariate analysis to identify potential resource incidents or potential service incidents. In an additional variation, it uses one or more potential resource incidents as independent variables and one or more potential service incidents as dependent variables in a multivariate analysis of historical data on incidents to identify additional potential resource incidents, or potential service incidents. The invention, in another variation, includes the further aspect of controlling service functionality by taking one or more of the following actions with respect to the network: scaling, reconfiguring, load balancing, managing traffic, and fault management.

In another variation of the method of the invention, the step of analyzing with an analytic mode includes: a) determining if an identified abnormal event is an abnormal resource event or an abnormal service event, b) selecting one of the following analytic modes to identify potential incidents: i) correlation analysis, ii) multivariate analysis, or iii) time series analysis, c) selecting independent and dependent variables to conduct the analysis with the selected analytic mode, d) selecting criteria for identifying a potential incident, e) applying the selected analytic mode based on the selected variables and the selected criteria to identify potential incidents, and f) determining if an identified potential incident is a potential resource incident or a potential service incident.

The invention provides a computer program product for controlling service functionality of a distributed network on a computer readable storage medium that includes: 1) program instructions for monitoring metrics of a plurality of distributed network factors, 2) program instructions for formulating control charts based on the metrics monitored, 3) program instructions for detecting abnormal events by applying Nelson Rules to the control charts, 4) program instructions for predicting if any abnormal event indicates a potential incident by analyzing the abnormal events with a predetermined analytic mode, and 5) program instructions for controlling service functionality of the network based information regarding the detected events and the potential incidents. The program instructions are stored on a computer readable storage medium.

The computer program product in which analyzing with a predetermined analytic mode includes analyzing by one or more of the following analytic modes: correlation analysis of abnormal events detected using Nelson Rules wherein the abnormal events are used as variables in the analysis, multivariate analysis, and time series analysis of control chart data. In yet another aspect of the computer program, it can include instructions for using one or more detected abnormal resource events as independent variables and one or more detected abnormal service events as dependent variables in a multivariate analysis to identify a potential resource incident or a potential service incident. In yet another aspect of the computer program, it includes instructions for use of one or more potential resource incidents as independent variables and one or more potential service incidents as dependent variables in a multivariate analysis of historical data on incidents to identify additional potential resource incidents or potential service incidents. In yet another aspect of the invention, controlling service functionality can include taking one or more of the following actions with respect to the network: scaling, reconfiguring, load balancing, managing traffic, and fault management.

In another variation of the computer program product, the program instructions of analyzing with a predetermined analytic mode includes: a) program instructions for determining if an identified abnormal event is an abnormal resource event or an abnormal service event, b) program instructions for selecting one of the following analytic modes to identify potential incidents: i) correlation analysis, ii) multivariate analysis, or iii) time series analysis, c) program instructions for selecting independent and dependent variables to conduct the analysis with the selected analytic mode, d) program instructions for selecting criteria for identifying a potential incident, e) program instructions for applying the selected analytic mode based on the selected variables and the selected criteria to identify potential incidents, and f) program instructions for determining if an identified potential incident is a potential resource incidents or a potential service incident. All of these program instructions also being stored on a computer readable medium.

An engine for control of service functionality of a distributed network that includes: a computer readable storage medium, a processor operatively coupled to the storage medium and also operatively coupled to external factor monitors, service factor monitors, resource factor monitors in the distributed network, an intelligent analytics engine operatively connected to the processor and the storage medium and having: 1) program instructions for formulating into control charts metrics gathered from the external factor monitors, the service factor monitors, and the resource factor monitors, 2) program instructions for detecting abnormal service events and abnormal resource events by applying Nelson style rules to the control charts, 3) program instructions for identifying potential resource incidents and potential service incidents by analyzing the detected abnormal resource events and the detected abnormal service events with a predetermined analytic mode, and 4) program instructions for sending information on the detected service events, the detected resource events, the identified potential resource incidents, and the identified potential service incidents to a network control center to aid in controlling resource and service functionality of the distributed network. The program instructions all are stored on the computer readable medium.

In a further aspect of the intelligent analytic engine, analyzing with a predetermined analytic mode includes analyzing by one or more of the following analytic modes: correlation analysis of abnormal events detected using Nelson type rules wherein the abnormal events are used as variables in the analysis, multivariate analysis, and time series analysis of control chart data.

In another aspect of the intelligent analytic engine, it includes instructions for using one or more detected abnormal resource event as an independent variable and using one or more detected abnormal service level event as a dependent variable in a multivariate analysis to identify a potential resource incident or a potential service incident. In yet a further aspect of the intelligent analytic engine, it includes instructions for using the potential resource incidents as independent variables and using the potential service incidents as a dependent variables in a multivariate analysis of historical data on incidents to identify additional potential resource incidents or potential service incidents.

In another aspect of the engine, controlling service functionality at a network control center includes taking one or more of the following actions with respect to the network: scaling, reconfiguring, load balancing, managing traffic, and fault management.

In yet another aspect of the engine, the program instructions of analyzing with a predetermined analytic mode can include the following program instructions: 1) instructions for selecting one of the following analytic modes to identify potential incidents: i) correlation analysis, ii) multivariate analysis, or iii) time series analysis, 2) instructions for selecting independent and dependent variables to conduct the analysis with the selected analytic mode, 3) instructions for selecting criteria for identifying potential incidents, 4) instructions for applying the selected analytic mode based on the selected variables and the selected criteria to identify potential incidents, 5) instructions for determining if an identified potential incident is a potential resource incident or a potential service incident, and all of the program instructions are stored on said computer readable storage medium.

### BRIEF DESCRIPTION OF THE DRAWINGS

These and other features of the invention will be more readily understood from the following detailed description of the various aspects of the invention taken in conjunction with the accompanying drawings in which:

FIG. 1 depicts a method flow diagram in accordance with an embodiment of the present invention;

FIG. 2 presents a graphical representation of a control chart according to an embodiment of the present invention;

FIG. 3 present a graphical representation of another control chart according to an embodiment of the present inventions;

FIG. 4 depicts a flow chart diagram in accordance with an embodiment of the present invention;

FIG. 5 depicts a process flow diagram in accordance with an embodiment of the present invention;

FIG. 6 depicts a network implementation of an embodiment of the present invention; and

FIG. 7 depicts an architectural diagram in accordance with an embodiment of the present invention.

### DETAILED DESCRIPTION

The description of the various embodiments of the present invention have been presented for purposes of illustration, but are not intended to be exhaustive or limited to embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is understood in advance that although this disclosure includes a somewhat detailed description of the implementation of the invention on a distributed computing network, implementation of the teachings recited herein are not limited to complex distributed computing networks or cloud service or environments. Rather, embodiments of the present invention are capable of being implemented in conjunction with many types of computing environments or data processing environments now know or later to be developed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of the variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language, such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer, for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process, such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As noted above, embodiments of the present invention provide for a system, apparatus and method for monitoring the functionality of a computing network such as a distributed network or a cloud computing network or any other type of interrelated computer or data processing network. The invention looks for patterns in the metrics of the various components, elements or functionalities of the network that indicate the occurrence of abnormal events, and then, by further statistical analysis, looks for potential incidents, generally resource or service incidents. The invention does this by aggregating the information on the metrics of various elements, component and factors of the system on a real time basis into control charts. Nelson type rules are then applied to the control charts on a periodic basis in real time to identify abnormal events more specifically abnormal service or resource events. Once an abnormal event is identified further, statistical analysis using covariate analysis, multivariate analysis, time series analysis or other statistical techniques, which in part often, but not always, refer to historical data, then determine if the abnormal event may indicate the potential for a service incident or resource incident. Based on the identified abnormal service events and abnormal resource events and potential service and potential resource incidents, the system can implement proactive solutions to prevent the occurrence of the identified potential service or resource incidents from degrading, disrupting or interrupting operation of the network or system.

The embodiment described herein of the present invention as noted above monitors, collects and analyzes metrics from various elements, of the network. Every element of a distributed, cloud or similar network has a unique identification (ID) in the network. For example, they can be configuration ID's in the configuration management information system (CMIS). These elements consist of physical hardware such as storage devices, routers, IP load balancers, SSL accelerators, NAS file servers, etc. Virtual devices, appliances and firmware are also included in this category. In an autonomic computing system, the various elements and components have monitors and sensors built into them that monitor the various elements and components and can provide a data stream of relevant metrics from each of the elements with which the system formulates control charts. In a non-autonomic system, monitors and sensors can be added to monitor operation and create the necessary data streams of metrics needed to create control charts according to various embodiments of the present invention. The various metrics monitored of these elements are typically, but not exclusively, time related metrics such as seek time, access time, latency etc.

The embodiment of the present invention also uses metrics from various components of the network being monitored such components being functionalities, vital business functions, and other service features of the network. These components typically rely and are made up of multiple elements or components of the network. For example, an on line banking application, such as one that allows a customer to go on line to generate a monthly banking statement, provides a simple example of such a service level application or functionality that relies on various elements and components of the system. To effectuate such a functionality, perhaps fifteen or more elements at the resource level and components at the service level need to be activated and work together in order to provide the requested monthly statement. The components, the functionalities, vital business functions or service aspects of a network, or system naturally depend on the type of computer network and system and what the network and system is used for, whether it is that of a financial institution, manufacturer, or whatever. In the example of a customer seeking a copy of a monthly statement, various elements, such as routers, servers, storage devices, etc., are activated in response to the demand. Additionally, various components, such as virtual systems ranging from virus checkers to security protocols, and other service features are activated to achieve the final result, a copy of the monthly statement for the customer to view, download, print, or conduct any other relevant business. The actual metrics of each functionality, vital business function, or service also varies and typically is some type of response time or other time related metric of the system, but not necessarily in all cases. For purposes of clarity, and simplification, the term “factors” will be used in this disclosure as a term inclusive of the terms elements, components, functionalities, and vital business functions.

There are many software programs available to allow one to map the various elements, components, functionalities, vital business functions, and service features of a network or system to thereby identify all of the elements, components and functionalities of the network or system necessary for the system to properly function. Additionally, these and other programs include means to monitor and generate a data stream of relevant metrics of these factors under consideration. As noted above for purposes of clarity and simplification, the term “factors” will be used in this disclosure as a term inclusive of the terms elements, components, functionalities and, vital business.

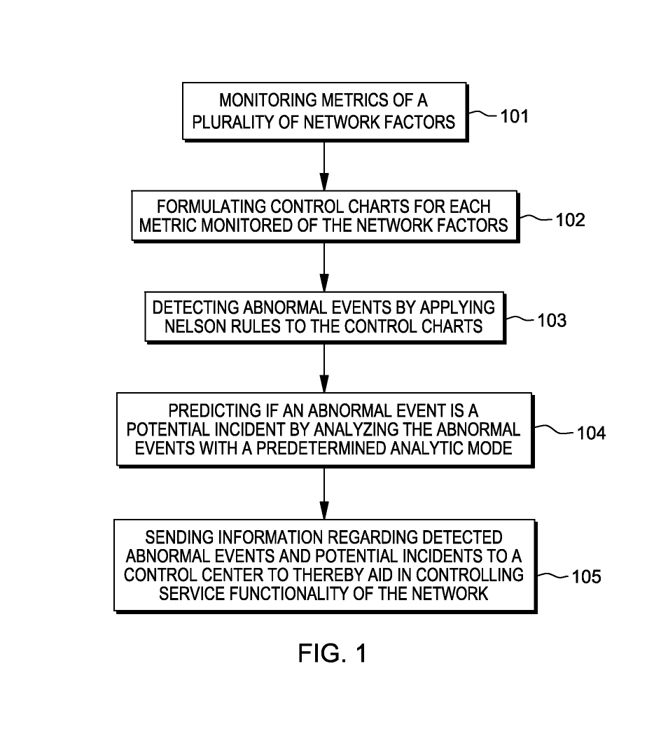

FIG. 1, a method flow diagram according to an embodiment of the present invention, provides an overview of the process or method of an embodiment of the present invention. At step 101, the system monitors various metrics of the factors of the system or network. At step 102, it formulates the metrics monitored into control charts. At step 103, Nelson like rules are applied to the control charts to identify abnormal events. At step 104, further analyses with various predetermined analytic modes predicts if the abnormal event or events may presage and identify potential incidents. At step 105, the method or system sends the information on identified abnormal events and potential incidents to a control center or enterprise management center for operational actions to prevent the potential incidents from becoming actual incidents. Alternatively, the information on abnormal events or potential incidents in an autonomic system is sent to a decision making unit of that autonomic system for determination of what action is necessary to prevent the potential incidents from becoming an incident or incidents in fact. Detailed discussions of each of the steps of FIG. 1 outlined above follows.

Referring again to FIG. 1 at step 101, the system monitors the metrics of various factors of the network. As noted above, these can vary from hardware and firmware elements to various functionalities of network or system, including vital business functions, and service factors at the resource and or service level of the system. Additionally, as noted above, each of these factors of the network have various metrics, such as seek time, response time, load capacity, etc., associated with them. The system monitors the selected metrics of the various factors on a real time basis.

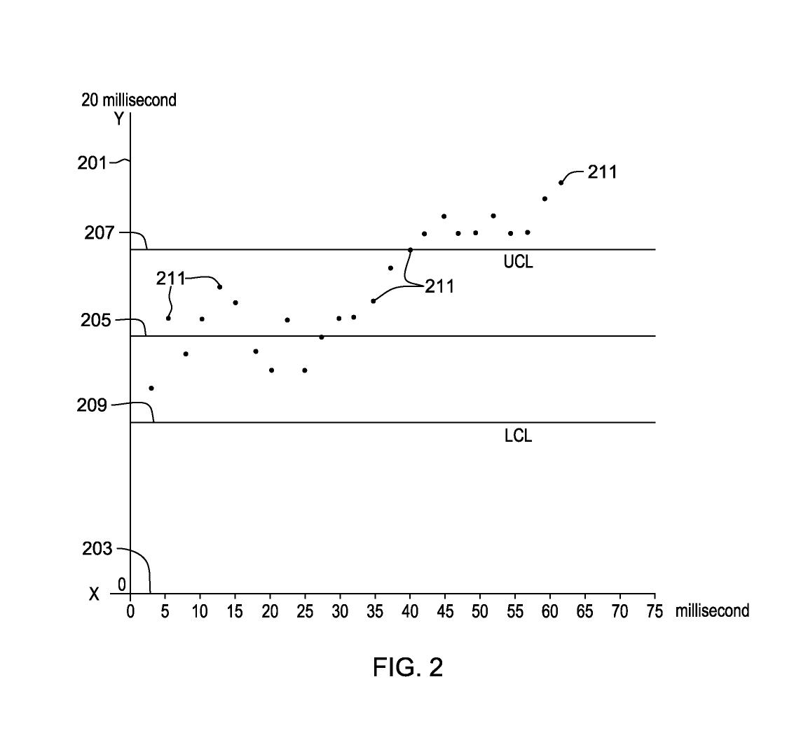

At step 102, FIG. 1, the metrics collected on each of the factors are aggregated into control charts on a real time basis and updated constantly in real time. For example, if the metric monitored is the response time of a storage device, this would be constantly updated in real time. FIG. 2 presents a graphical representation of one variation of a control chart that could be formulated from the monitored metrics in an embodiment of the present invention. In actual practice, the control chart would most likely be programmed into a software or firmware embodiment of the invention as a functional aspect. In FIG. 2, the Y-axis 201 represents the value of the metric being monitored, which in this example is the response time of a storage device in milliseconds; however, in practice, the values on the Y-axis will be dependent on the factor of the network and the metric of that factor being monitored. Such time periods could range for micro seconds to seconds and perhaps be a totally different parameter, again dependent on the metric or metrics being monitored. The X-axis 203 represents the time periods during which samples of the metric are being recorded, which in the present example is on a tenth of a second basis. However, the actual sampling time interval will also vary depending on the factor and metric of that factor being monitored. Line 205 represents the mean value of the metric being monitored when the factor from which the metric is being gathered from is functioning properly and within normal predetermined parameters. Line UCL 207 is the upper control limit, and line LCL 209 is the lower control limit. In the example shown, the series of dots numbered 211 are readings for the actual response time metric of the storage device taken each tenth of a second.

The value or location of the mean line 205 and the UCL 207 and LCL 209 on the control chart depends in part on past experience of the normal range of the metric for the factor being monitored when it exhibits readings that indicate it is operating under control and within normal predetermined operating parameters. To an extent, the UCL and LCL are arbitrary lines in that one is actually setting the probability limits the chart will be working under. For example, the control limit lines UCL and LCL can be set so that almost all of the data points for the metric being monitored fall within these limits so long as the factor that is being monitored is operating within acceptable parameters and its operation remains in control. However, this can be varied more or less depending on risk tolerance deemed appropriate among other things. Thus, as those skilled in the art know, where the UCL and LCL values or lines are set, in part depends on the amount of risk that is acceptable to the system operator with respect to the factor being monitored. However, these aspects of the nature of control charts make the present invention a highly flexible aspect of an embodiment of the invention and will be discussed in more detail below regarding the step of identifying events and predicting potential incidents. Another term for upper control limit lines or the lower control limit lines are the upper specified limits or lower specified limits. Additionally, as those skilled in the art know that the LCL or UCL also can and typically are set at one or more standard deviations from the mean response line. Also, each of the lines UCL and LCL do not have to be set at the same distance from the mean line but can very based on the probability range desired in the monitoring, etc.

While the metric being discussed with respect to FIG. 2 is that of a hardware element of the system, namely the response time of a storage device, there are other metrics of that particular device that can be measured, including seek time, latency, etc. In fact, when a user of the system makes a demand for information which requires a number of different operations, including access to the storage device, the response time the end user sees is another metric, the overall time the system takes to provide the requested information, which is at the service level of the system. The first metric, the response time of the storage device, is at the resource level of the system which the end user obviously will not perceive directly. The second is the response time of the entire system which the end user perceives and is at the service level of the system. Various functionalities, vital business functions, and service aspects of the network or system fall into this service category.

Thus, as noted above, the relevant metrics monitored can be of any quantifiable aspect of any factor of the network and not limited to discreet hardware elements as noted above. These could include metrics that relate the route of information taken in the network, such as link utilization, speed of path, throughput, packet loss, latency, path bandwidth, load, etc. Additionally, the metrics being monitored could relate to the software operating in the system including, but not limited to, the operating system itself. Metrics of functions of the network can also be monitored, such as vital business functions of the system, which typically depend on many hardware elements, software elements, virtual systems, and other elements of the network working in combination.

While there are perhaps hundreds, and maybe even thousands, of metrics that can be monitored and used in different embodiments of the present invention, as a practical matter, the actual metrics monitored would be those that generate patterns that have a causal relation to predicting abnormal events and helping to identify potential resource and service incidents. Some of the metrics can be identified by the type of network and system monitored, and some can be identified through experience from monitoring a network and establishing a causal link between identified abnormal events and predicted and actual incidents.

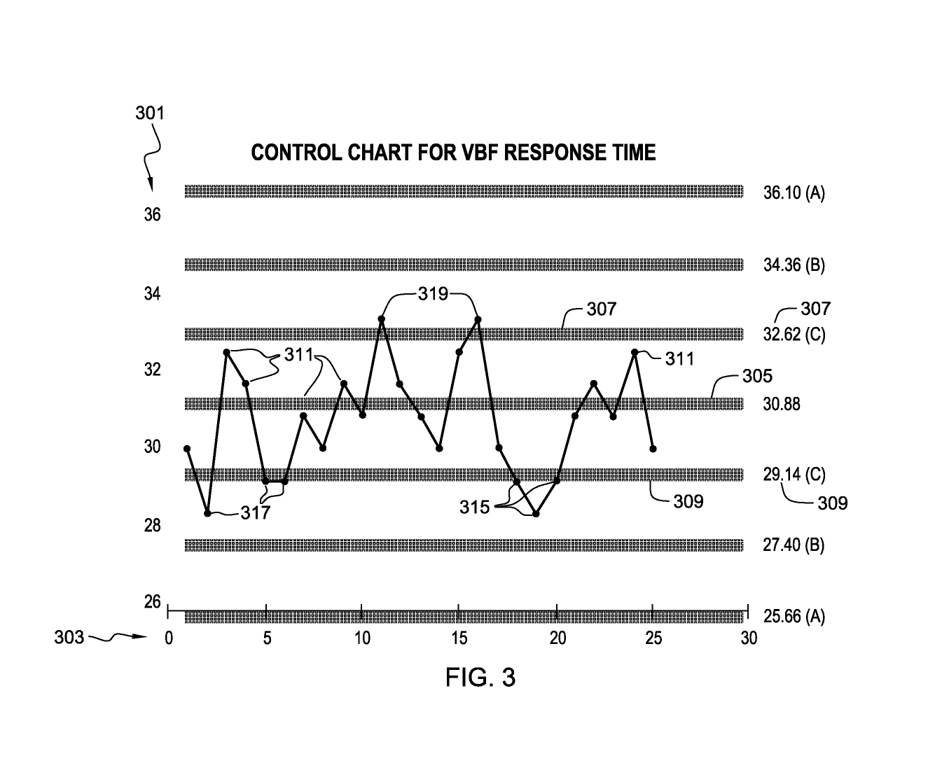

FIG. 3 is a graphical representation of another example of a control chart, the response time metric of a vital business function. A vital business function being a function of a service being provided by a business, the proper functioning of which is critical to the success of the business. For example, the ability of customers to obtain 24-hour access to online banking accounts would be a vital business function of a financial institution. As noted above, vital business functions are dependent on a number of hardware elements, components, and functionalities in the system, all of which play a significant role in the vital business function, the failure of any one of them could affect the proper function of the vital business function and result in a resource or service incident.

The metric monitored and recorded on the control chart in FIG. 3 is the response time of the vital business function. The Y-Axis 301 is the response range in which the vital business function depicted in the chart in FIG. 3 operates when operating in normal and acceptable parameters. The specific range in the example presented being 36 milliseconds to 26 milliseconds. The X-Axis 303 is the sampling time periods for which readings are taken, in the particular examples shown here namely a second by second basis indicated on the X-Axis. Line 305 at 30.88 milliseconds is the mean response time of the vital business function metric when the vital business function is operating within normal parameters. The UCL is 307 is set at 32.62 milliseconds and the LCL is 309 is at a 29.14 milliseconds. As depicted in FIG. 3, readings are taken every second of the response time of the particular vital business function. For purposes of discussion, the examples depicted in FIG. 3 of readings of the response time that fall between the UCL 307 and above LCL 309 within the anticipated range of operation are identified by the number 311. Any readings falling above the upper control limit are numbered 319, and readings appearing below the lower control line are numbered 317 or 315. This aspect will be discussed in more detail below.

Referring back to FIG. 1 at the next step 103, Nelson Rules or Nelson like rules are applied in real time on a periodic basis to the control charts to detect occurrence of abnormal events. Nelson or similar types of rules are well known in the art of process control and are used to identify non-random or out of control conditions in the system being monitored. Typically, Nelson or similar types of rules are based around the mean value and standard deviation of the samples taken. Nelson Rules or similar types of rules specify certain patterns which when they appear in the data points of a data stream of a monitored metric indicate the potential of an out of control or non-random event occurring, an “abnormal event” for the purposes of this disclosure. When properly applied according to an embodiment of the present invention to the control charts created in the previous step 102, they can identify abnormal events occurring in the functioning of the distributed network, specifically abnormal events related to the function from which the metric of the control chart was derived. For example, referring to FIG. 2, data points 211 from the 0 about the 30^{th} tenth of a second mark appear to be random and confined between lines LCL and UCL of that chart and do not fit the criteria for the standard Nelson Rules or similar types of pattern recognition rules. Thus, during this sampling period, there appear to be no abnormal events. However, data points from 30^{th} tenth of a second mark to the 45^{th} tenth of a second mark indicate a trend and fulfill a Nelson Rule pattern; and according to the teachings of an embodiment of the present invention, this would be an abnormal event. Likewise, from the 45^{th} tenth of a second mark on all of the data points are above the upper control line. This is another example of the meeting of Nelson Rule criteria. Thus, according to an embodiment of the present invention this would also be an abnormal event also.

FIG. 3 provides an additional example of how application of Nelson Rules or similar pattern rules to a control chart data stream identifies an abnormal event or events. Three groups of data points in FIG. 3 are of interests, groups 315, 317, and 319. Each group alone would trigger the Nelson rules and thus indicates an abnormal event because they are either above the UCL, namely data points 319, or below the LCL, namely data points 317 and 315. Additionally, the fact that the three data points of group 315 are consecutive breaches of the LCL trigger another pattern of the Nelson Rules and thus indicates an abnormal event. Additionally, all three groups 315, 317, and 319 taken together create a pattern triggering another Nelson Rule pattern indicating that some elements, components, or other factors of the underlying system on which the vital business function relies on to operate properly may be going out of control as indicated by the oscillation of the data points above and below the UCL 307 and above LCL 309 lines. Thus, application of Nelson type Rules to the control chart in FIG. 3 indicates several abnormal events that need further analysis in the next step of an embodiment of the present invention to determine if they predict a potential service or resource incident. As used in this disclosure, an abnormal event is any part of the data stream of the metric monitored that when formulated into a control chart, triggers a Nelson Rule or similar type of pattern recognition rule, such as meets the criteria of a Nelson Rule or similar type of rule.

Once the embodiment of the invention described herein detects an abnormal event, it then determines if it is an abnormal resource event or an abnormal service event. For the purposes of this disclosure, an abnormal resource event is an abnormal event that relates to the function of a resource or an element of the network (such as a storage enclosure or network router). An abnormal service event is an abnormal event that relates to one or more service components of the network (such as application functionality response time or application component failure). Thus, an embodiment of the invention classifies abnormal events as either abnormal resource or service events based on the preceding criteria.

The detected abnormal resource and abnormal service events are analyzed at the next step 104 using one of several analytic modes to determine if the identified abnormal event or events indicate a potential for one or more resource and/or service incident or incidents. Examples of various analytic modes of an embodiment of the present invention include: a) correlation analysis of abnormal events detected using Nelson Rules wherein the occurrences of abnormal events (occurrence coded as 1 and non occurrence coded as 0) are used as variables in the bivariate analysis, b) multivariate analysis, and c) time series analysis of control chart data. This is not an exhaustive list since once those skilled in the art understand the method and process of the present invention other potential analytic modes will become apparent.

Correlation analysis as a bivariate analytical technique typically refers to determining or identifying dependence between two different variables. An example of such a dependence that has relevance to an embodiment of the present invention is the relationship between application functionality response time and associated storage (read or write activity) related data seek time. The application functionality could be about finding and displaying historical billing statements (say for the past one year) and the seek time associated with the amount of time the storage systems take to find/locate the files/data associated with these billing statements.

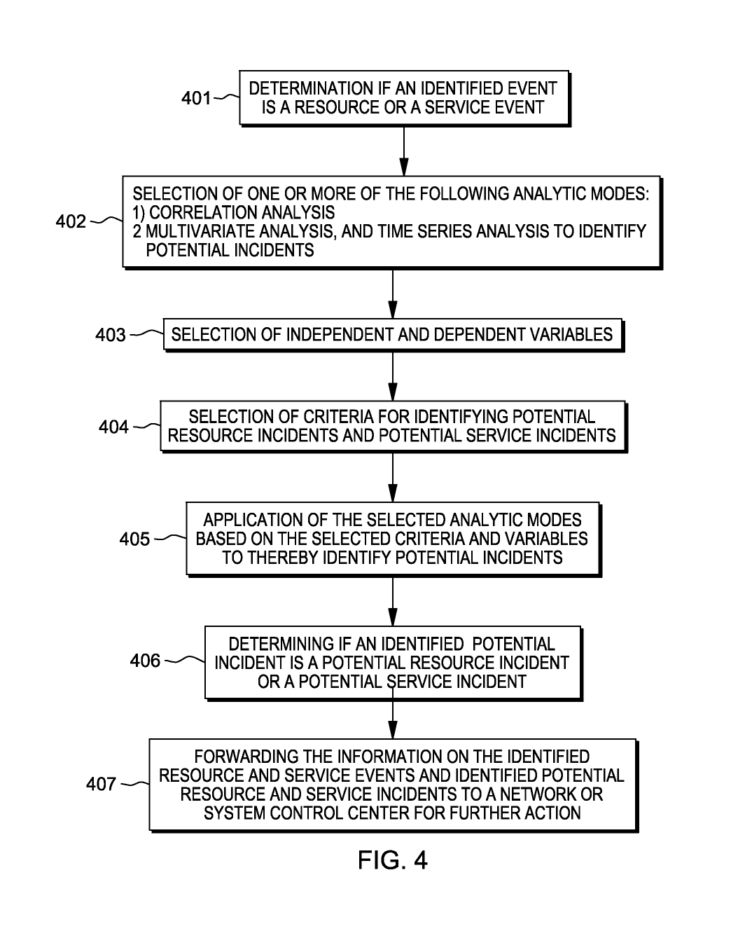

The following is an example of application of the correlation analytic mode. Two abnormal resource events were identified above when Nelson like rules were applied to FIG. 2, a graphic depiction of a control chart of the response time metric of a storage disk. Referring to FIG. 4, the first step 401 determines if the abnormal events are abnormal resource event or abnormal service event. As defined above, an abnormal resource event is an event identified by application of Nelson Rules to a control chart metric of a resource (for the purpose of this invention). Thus, since all of the events in this example are derived from applying Nelson Rules to the response time metric of the disk these are then all abnormal resource events. The next step is a selection of one or more of the analytic modes 402. In this example, we are using correlation analysis. At step 403, we select the variables. For the independent variable, we can select from a number of independent variables that have relevance. These include the monitored metric, the seek time of the disk, as well, as the two abnormal resource events identified, which can be used either individually or in combination. For the purpose of this example, we shall use for the independent variable the two abnormal resource events in combination. For the dependent variable, we select the occurrence of the incident, a failure of the disk to preform to desired specifications (which is a resource incident).

At the next step 404, the embodiment of the invention discussed herein sets the criteria for identifying potential resource and potential service incidents. For the example under discussion, the actual criteria can range from an outright failure to high probability of potential failure to a very low probability of potential failure of the disk. As noted elsewhere herein, actual selection of the criteria for determining both events and incidents can vary significantly depending on the risk tolerance of the network or system operator and the needs of the network system or operator to avoid disruptions or degradations. For example, large financial institutions that are dependent on retail clients would tend to have a very low risk tolerance and within certain costs constraints would want to take action even on a relatively low degree of probability of failure in the system or network to thereby prevent any degradation of system function and possible disruption of the system or network that slows, inhibits or prevents a client's access to online accounts. In setting the criteria, one would in most instances look at both the history of the failure rate, etc., of particular type of storage device and the manufactures specifications [most storage vendors provide historical data and test results data on such metrics as MTBF or Mean Time Between Failure for hard drives and/or JBODs (Just a Bunch of Disks) and/or Storage Systems]. One would also in this calculation account for the specific metadata about the storage device being monitored including age, recent events associated with the storage device, etc. Given this analysis, the system or network operator may set a probability limit of failure that exceeds say 45% with respect to the relationship between the independent and dependent variable as the trigger that an abnormal resource event has happened with respect to the configuration item monitored, the storage device in this example.

At step 405, the analytic mode selected is applied to analyze the variables selected. During the application of the correlation analyses at step 405, assume that the breaking of two Nelson like rules (the abnormal events) within a matter of minutes indicates a potential for disk failure of 49%. Since this probability exceeds the 45% probability limit set, it is therefore indicative that this is an identified potential incident. However, as noted above, the actual criteria selected can vary significantly depending on the needs of the particular network or system. At step 406, a determination is made as to whether or not the correlation analysis had identified a potential resource incident or a potential service incident. In the present case, it is a resource incident since it concerns possible failure of a storage disk.

Finally at step 407, the information regarding the identified abnormal resource events and identified potential resource incident is forwarded to a control center or operation center. At the control center or operations center, action can be taken as previously noted. Such action may be based on additional information, such as the age of the disk, the manufacturer's specification with respect to anticipated life, etc. In such instances, they may mandate a replacement of the disk and other remedial actions, such as copying of the contents to create a point in time backup if the disk fails, etc.

The following is an example of application of correlation analysis of abnormal service events to determine if the abnormal service event presages and helps with predicting a potential resource incident or a potential service incident. FIG. 3, as noted above, is a graphical representation of a response time metric of a vital business function, which could be the providing of a financial statement over the internet to a customer of a financial institution. As noted above, application of Nelson Rules indicated the occurrence of several service incidents 401 FIG. 4. For the purpose of this example, we are using correlation analysis 402. Potential independent variables are: the metric monitored, the response time of the vital business function, or each of the three identified service events individually or in combination. The dependent variable will be the failure of the vital business function to perform to minimum acceptable standards (say less than 6 seconds to download page with selected statement) set in the SLA or Service Level Agreement (between the service provider and their client) or set via informal customer expectations 403.

The criteria 404 that will be used to identify potential incidents will be indications that the vital business function has at least a 45% chance of performing below a preset minimum threshold. As noted above, the criteria for identifying potential service or potential resource incidents is very flexible and in part dependent on the degree of operation free error that the service provider wants to achieve. For the purpose of this example, let us assume that correlation analysis 405 indicates that the breaking of three Nelson Rules within a two second time period indicates a 53% probability of the vital business function at some future point failing to perform to minimum standards or actually failing upon application of correlation analysis. Since the 53% is above the 45% threshold level, this then identifies a potential service incident.

Since the analysis of the service events has led to identification of a potential incident and it appears it could affect the overall operation of the vital business function, this necessarily will indicate a potential service incident 406. The information regarding the abnormal service events and identified potential service incident are then sent to a service provider's control center or operations center 407. There are any number of actions that can be taken, one perhaps being review of all of the different components that enable the vital business function.

Multivariate analysis or multivariate statistics is the observation and analysis of more than one statistical variable at a time. Correlation analysis is a special case of multivariate analysis in that it only compares one independent and one dependent variable. Multivariate analysis compares multiple independent variables to one or more dependent variable. An example of an embodiment of this invention that employees multivariate analysis is the use of the occurrence (an non occurrence of) multiple abnormal resource events in combination as independent variables and an abnormal service event or events in combination as a dependent variable or variables respectively. Examples of independent variable/resource events are: a) resource response time events that break nelson rules, b) resource events that break certain resource utilization thresholds, c) resource related faults and error conditions, and d) resource related unauthorized changes, and so on. Examples of dependent variables or abnormal service events are service functionality response times and service functionality availability. Also, using a predicted potential resource incident as an independent variable and using a predicted potential service incident as a dependent variable in a multivariate analysis of historical data on incidents to identify additional potential resource incidents or potential service incidents is another example. The variance in application response time can be explained by a combination of multiple variables, such as network response times, server performance and response time, and storage performance and response times. The variance in application response time can be explained (and service response time events/incidents can be predicted) by or with a combination of multiple variables, such as network response times, server performance and response time, and storage performance and response times, among others. Examples of multivariate analysis that can be applied include analysis of variance (ANOVA), multivariate analysis of variance (MANOVA), Regression Analysis, Discriminant Analysis, and Factor Analysis among others.

Those skilled in the art of multivariate analysis will realize that there are many ways and many approaches to applying this technique given the parameters outlined in this disclosure. Thus, a simple example will demonstrate its applicability. Assume a system or network in which the operator of that system or network wants to identify potential resource incidents with respect to a storage area network (SAN) that forms a part of the system or network. There are literally hundreds of potential metrics that could be monitored with respect to the SAN. Such a SAN may have ten enclosures identified zero to nine. Each of these enclosures has multiple disks. The network operator may want to be made aware of potential resource incidents, such as failure of one or more of the disks in the enclosures or the overall SAN fabric network that ties the SAN together with the connection it has to the service network and service systems (example: application servers).

For example, assume FIG. 2 is a control chart of the access time for a specific storage device in one of the enclosures of the SAN. As noted above, when Nelson Rules were used to analyze this control chart, it was determined at least two resource events had occurred with respect to the specific disk related to that control chart. Naturally, a control chart for each disk in the SAN would be created. Thus, referring to FIG. 4, the events identified are resource events 401. The analytic mode chosen is multivariate analysis 402.

There are a large number of variables that can be used in multivariate analysis, but as a practical matter, the variables selected will be those that have a high degree or at least a moderate degree of correlation with the potential failure of the disk, the dependent variable or variables. The independent variables 403 selected because of their relevance could be: 1) the abnormal resource events detected when Nelson Rules were applied to the control chart in FIG. 2, 2) the age of the disk, 3) the manufacturer's specifications, including, but not limited to, potential hardware life of the disks, 4) the seek time of each particular disk during operation (the metric monitored for identifying the resource events), 5) the caching time (to cache from hard disk to storage memory) of each particular disk, and 6) the error correction rate with respect to each of the disks and the data for these independent variables is collected over set time periods.

In the version of the embodiment of the invention discussed herein the probability then would be set with respect to each of the independent variables as part of step 403. Determination of specific probabilities, with respect to the age of the disk, given the effective useful life of the disk based on manufactures specification the sending rate of probability reached on this age would be used. Seek time, probabilities could be set based on the seek time operating history of the same or similar disks. In a similar manner, the probability of failure based on the values of each of the other variables would be based on prior experience, historical data, and etc.

Referring to FIG. 4, step 404 of the process of selection of the criteria for identification of a potential incident will be set based an aggregate probability arrived at by combining the individual probability of each independent variable in relation to the dependent variable or variables. The actual value of the probability that would trigger identification of a potential resource or service incident, as noted above, will depend on the risk aversion and tolerance for disruption or degradation of network or system by the network and system operator. For the sake of this example, let's assume the system operator sets the limit for the aggregate probability of failure at 20%.

Upon application of the multivariate analysis 405, assume the aggregate probability of failure is 27%, this would result in a determination 406 or identification of a potential resource incident in the future for this particular disk in the SAN. The information regarding the resource events and potential resource incident is then sent 407 to the systems control center for action which could include replacement of the disk, copying of its contents to a backed up, or replicated to another disk, etc.

In the example of the SAN provided above as noted, metrics of each of the physical disks that make up the memory medium of the SAN would be monitored, control charts derived therefrom and analyzed using Nelson type rules for abnormal events. Upon the occurrence of an event analyzed using the multivariate analysis described herein, when an event is identified with respect to that particular disk. A general discussion of some additional variations of this embodiment of this analytic mode follows below.

In a similar fashion, the information regarding service events gathered from the examples from the analysis of FIG. 3 could be used in a multivariate analysis. Assume the metric of the vital business function depicted in FIG. 3 is the response time performance of an online banking system that provides copies of bank statements and copies of transactions, such as, checks and debit card transactions, etc., upon request of the end-user customer. In the example given above with respect to FIG. 3, application of Nelson like rules has detected several abnormal service events. The system then conducts a multivariate analysis in which the response time metric of the vital business function is a dependent variable. The independent variables in this analysis being relevant performance metrics associated with the factors or components that act together to enable the vital business function to operate: the web server, the application server, the data base server, the integration server, the access network, and the service network storage systems that store the bank statements, and copies of each transaction. The system then would take the metrics of these factors or components collected in real time and conduct multivariate analysis in real time with respect to the metrics gathered. This embodiment of the invention could conduct the multivariate analysis by referring to and looking for patterns in multivariate analysis of historical production (environment) data and test environmental data, which has indicated in the past the occurrence of certain abnormal resource events or abnormal service events associated with the various factors or components monitored that are likely to result in a potential service incident. Thus, in this variation of multivariate analysis comparison is made between patterns of current metrics monitored with patterns of historical metric data with respect to the factors or components monitored. Probability levels of the occurrence of incidents based on the historical data would be assigned to identify potential service incidents and notify the information technology (IT) operator about the potential service incident. Additionally, also extracted from the historical data, would be information concerning the time lag between the occurrence of the event or events and the occurrence of the subsequent incident or incidents. The IT operator then is immediately alerted about the high probability (highly likely) of a potential service incident associated with the online banking application or the abnormal service events with a potential prediction about time of the occurrence of the potential service incident (say within the next 10 minutes) and this allows the system IT operator to take appropriate action to avoid the potential service incident. Naturally, the data provided to the IT operator would include information about the metrics of the specific independent variable that would accordingly help the IT operator identify the actual source of the potential service incident predicted by this method or mode of multivariate analysis.

In another variation of this embodiment of the Invention, identified potential resource incidents can be used as independent variables and identified potential service incidents can be used as dependent variables in a variation of multivariate analysis. A relevant example would be multiple disks in a midrange storage system with built in redundancy that provides service for multiple applications that use the mid-range storage system. Reference is made to the previous example of the SAN storage system in which potential resource incidents were identified, assume that this SAN forms part of the factors that enables the vital business function analyzed with respect to FIG. 3 where potential service incidents were identified with respect to that vital business function. In a multivariate analysis, the potential resource incidents would be used as the independent and the potential service incidents would be utilized as dependent variables. A lengthy discussion of how this would be applied is not necessary here, since those skilled in the art once they understand the concepts expressed herein, the parameters and reflect on the previous examples can readily come up with various ways to conduct multivariate analysis. As an example, during such analysis with such a redundant system, there will most likely be near zero impact when one disk fails with some impact when two disks fail simultaneously. However, if there is a potential for multiple disk failures within a short period of time, this then would identify additional potential resource incidents and/or potential service incident. Responsive action by the IT operator could include, A) redirecting application traffic to alternate storage systems which have replicated data and/or, B) shutting down certain low priority and low impact applications which are also using the same storage system as the more important applications are given precedence.

As noted above, another variation of the analytic modes that can be used with this invention, although it does not make the list exhaustive, would be time series analysis. Time series analysis of control chart data could include analysis of moving averages, high points and low points (peaks and troughs) among others. Additionally, the following are additional relevant time series: moving averages of response times, moving averages of through put, and moving averages of utilization among others. All of these moving averages would most likely be used as independent variables. The dependent variable being the overall service factor that could be impacted or the resource factor that could be impacted or has been impacted by an abnormal event or events. The actual data for the time series analysis would be taken from the metrics contained in the control chart data. Naturally, this would be a time series analysis which studies the patterns associated with peak usage/performance, trough usage/performance, seasonality and time of day, time of week, time of month, time of quarter, 52 week high, 52 week low, among other time series parameters. In one variation of this invention, information of historic time series data could be analyzed for the identification of relationships between the various aspects of the time series analysis mentioned above and actual resource incidents or service incidents that have occurred in the past as a result of the abnormal events to thereby establish probability factors that could then aid in analyzing real time data obtained from analysis of the metrics of the various factors monitored in the system. Potential responses to the identified potential service incidents or identified potential resource incidents have already been discussed in detail above.

At step 105, information regarding detected abnormal service and resource events and predicted service and resource incidents are sent to a network or enterprise control center or an autonomic systems decision center for decisions to be made regarding actions to avert the predicted incidents from becoming incidents in fact and ultimately action to prevent the same from occurring. At the control center, such information can be used by those managing the system to determine if remedial action is necessary to prevent the identified potential incidents from becoming incidents in fact. Alternatively, as noted, an embodiment of the present invention could form part of an autonomic system and used by such a system to determine whether or not action is necessary to address the abnormal events and identified potential incidences to avoid either a service incident or a resource incident that can affect the operation of the resources of the system and/or degrade or interrupt the function of the system at the service level or otherwise.

Whether the actions to prevent disruption or degradation of the network or system are effectuated by some type of autonomic system or a human operator such actions can include, but are not limited to, load balancing, scaling, reconfiguration, traffic management, fault management or some similar actions. Since these are well known concepts in the computer and data processing field, a detailed discussion of them will not be undertaken. In brief, load balancing in part generally consists of the act of distributing work or redistributing work across a network or system to optimize over all operation and avoid potential problems caused by uneven distribution of work across the system. Scaling in part refers to a system or networks ability to increase the capacity of the system or network by adding additional resources to meet increased demand. Reconfiguring the network or system in part entails changing the data path, changing the function of hardware, switching functions between different hardware devices as different needs arise. As noted above, such acts of reconfiguring could include switching data to a different memory array when there are indications the one being used has the potential for involvement in a resource or service incident. Traffic management in part refers to optimizing the path of information passing between nodes in the network or system and through the system to maintain, speed, responsiveness and functionality of the system or network. Fault management is simply taking action with respect to potential identified problems, such as replacing hardware elements that appear to be on the verge of a resource incident, etc.

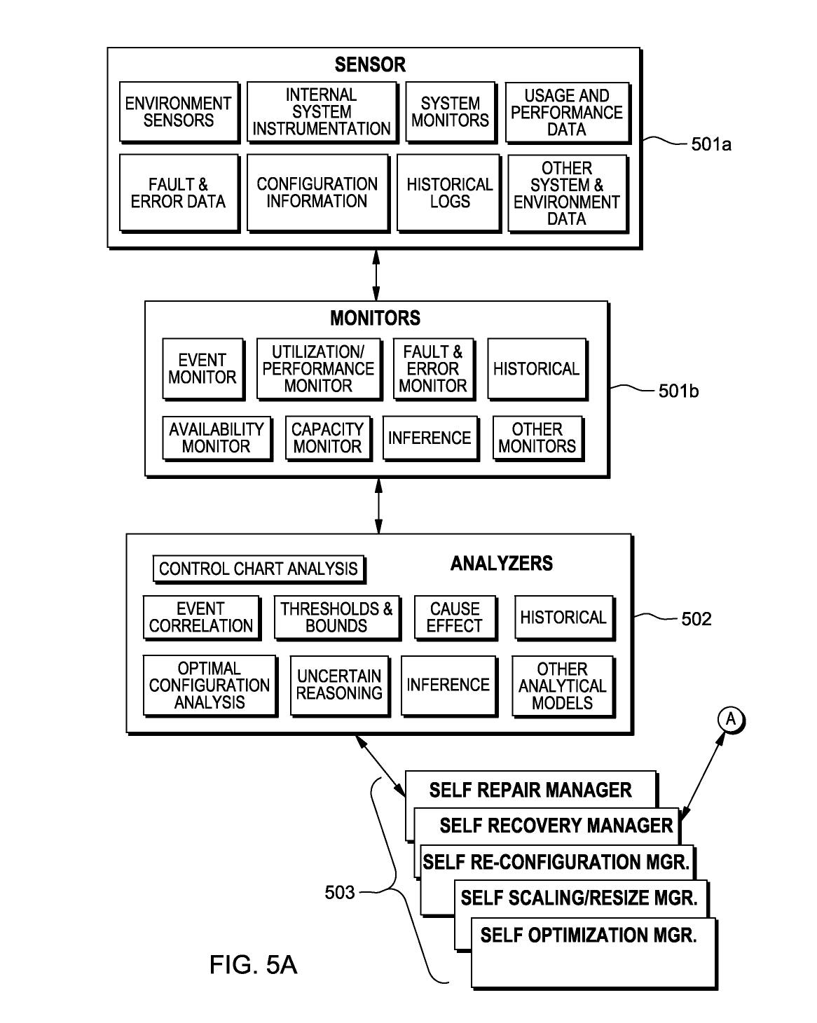

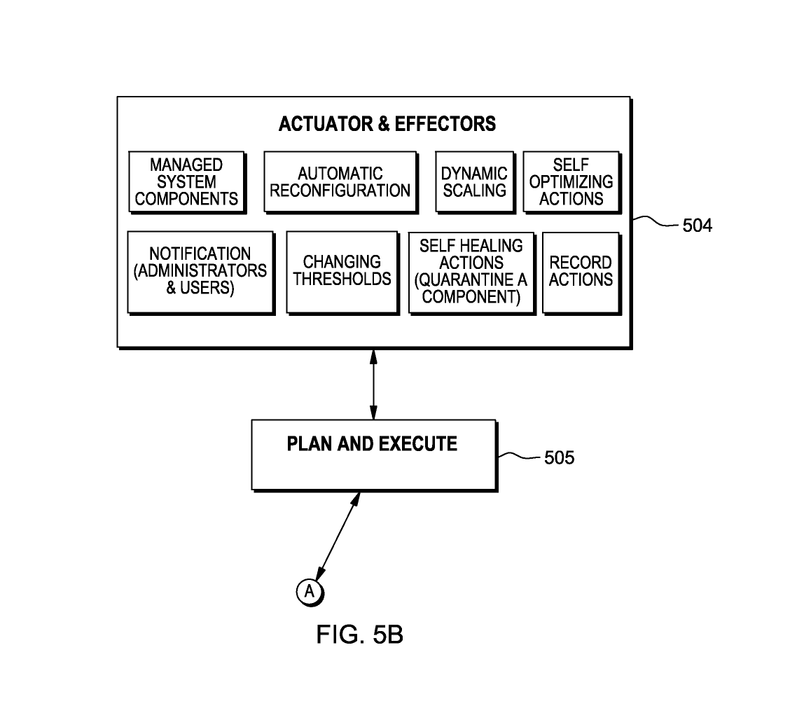

FIGS. 5A and 5B is a process flow diagram of autonomic computing reference architecture (ACRA) that incorporates an embodiment of the present invention. Four key components of such an embodiment are: 1) sensors and monitors, 2) analyzers, 3) self-repair-recovery-reconfiguration-self scaling resize-optimizer/manager and 4) planners, and effectors and actuators. The embodiment depicted of the ACRA implementation uses sensors and monitors at the service context level, service level, service system and resource level. Analyzers 502 at the heart of this embodiment of the invention, implement a method to analyze the data using control chart analysis as noted above wherein control charts derived from the data stream of monitored metrics are analyzed using Nelson type rules. Based on this analysis, this embodiment of the invention determines if an abnormal event has occurred and whether or not it is an abnormal resource event or an abnormal service event. It then uses various analytic modes as discussed above to determine if the abnormal service event or abnormal resource event predicts a potential service incident or potential resource incident and what preventive or proactive action can or should be taken. The system then plans and implements actions and provides direction to various actuators, effectors. The actuators/effectors then Plan and Execute actions to prevent the occurrence of the potential incident such actions, including but not limited to, self-scaling, self-reconfiguration, externally managed scaling, externally managed reconfiguration, or other proactive actions. The following paragraphs discuss the parts of this embodiment in a more detail.

Sensor 501A include: environmental sensors, internal system instrumentation, system monitors, usage and performance data, fault and error data, configuration information, historical logs, and other system and environmental data. Monitor 501B includes: an event monitor, utilization and performance monitor, fault and error monitor, availability monitor and capacity monitor. Additionally, monitor 501B includes relevant historical information and inference capabilities of monitors typical of an ACRA system. As noted, the sensor and monitor are at the service context level, service level, and service system and/or resource level of the embodiment depicted.

As noted above, the heart of this embodiment of the invention is at analyzers 502. Analyzers 502 take the metrics and other data gathered by the sensors and monitors and formulates the monitored metrics into control charts and applies Nelson type rules as the first step to thereby identify abnormal events, such as an abnormal service events or resource events. Upon identifying the particular abnormal event using further statistical analysis described above, such as the various analytic modes, it determines whether there is a potential for a service incident or resource incident. In its functional parts it includes capabilities and relevant usable information relating to event correlation, thresholds and boundaries, optimal configuration analysis, as well as historical data regarding previous abnormal events, and predicted and actual incidents with which to conduct its analysis as to whether the abnormal events or events predict a potential incident by using one or more of the analytic modes discussed above.

The information regarding abnormal events as well as potential service or resource incidents is forwarded to the self-control system 503. Based on instructions from the actuator-effectors 504 and plan and execute portion 505 of the system, which then makes a determination as to whether or not one or more of the options listed at 503 should be initiated to deal with the potential incident, namely activation of: 1) self-repair manager, 2) self-recovery manager, 3) self-re-configuration manager, 4) self-scaling/resize manager, and/or 5) self-optimization manager.

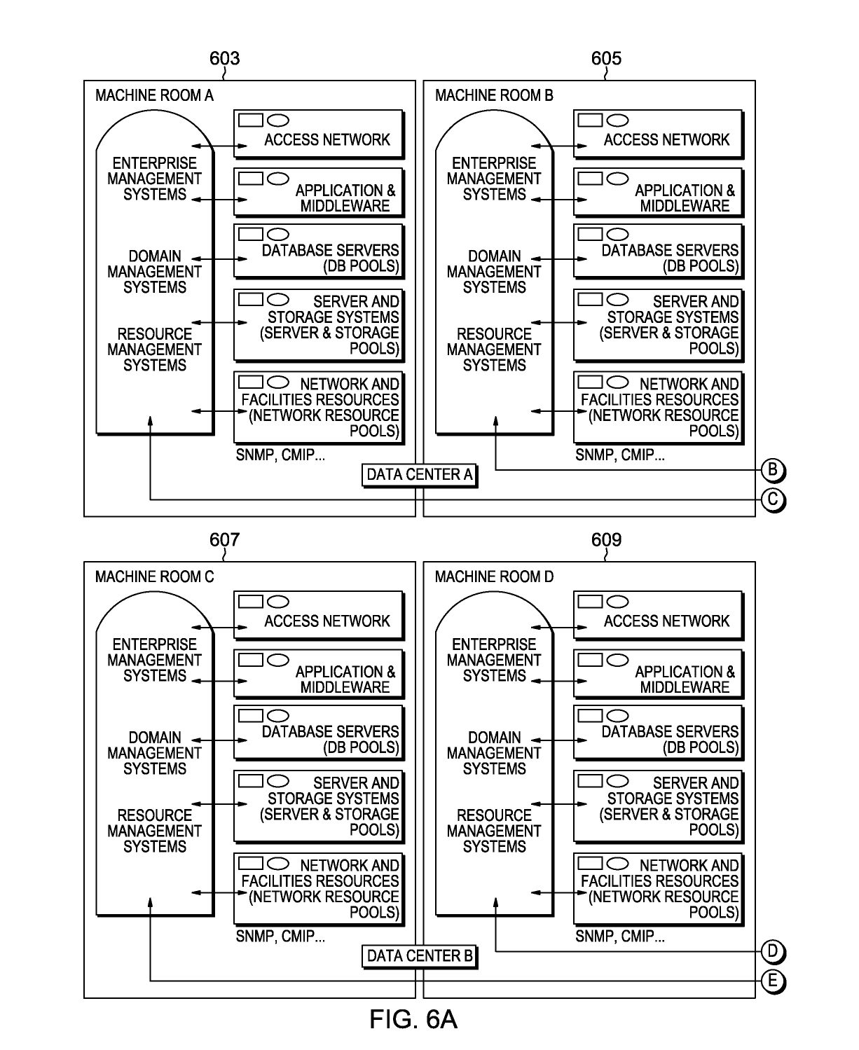

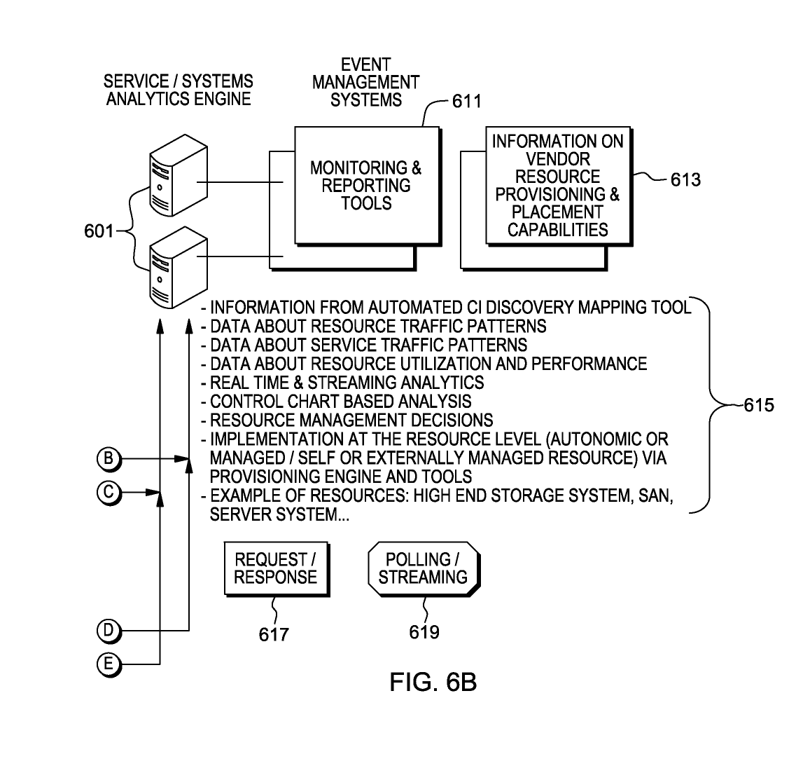

FIG. 6 depicts a distributed computer network that implements an embodiment of the present invention. The network consists of data center with machine room A 603 and machine room B 605 as well as data center B with machine room C 607 and machine room D 609. Each of the machine rooms, 603, 605, 607 & 609, have enterprise management systems, domain management systems, resource management systems, network access application and middleware, database servers and storage systems and network facilities and resources. These networks typically might be operating under a simple network management protocol or common management information protocol.

The managed services provided by the system depicted in FIG. 6 could include, but not be limited to, the messaging e-mail services, an e-commerce platform service, a distributed network of a corporation, either financial or manufacturing. The managed resources provided by the system depicted in FIG. 6 could include a high-end storage system, a high-end storage area network or high-end server systems.

In the embodiment of the invention incorporated into the system depicted in FIG. 6 the key portions of it are located in the service systems analytic engines, 601. The system's analytic engine as described above receives via Request and Response unit 617 and Polling and streaming unit 619 information listed at 615 namely: 1) information from the automated configuration items discovery and mapping tools, 2) data about resource traffic patterns (from monitoring tools), 3) data about service traffic patterns (from monitoring tools), 4) data about resource utilization and performance (from resource monitoring and management tools), and 5) real time streaming and analytics (using analytic tools). This information would include data about resource traffic patterns, data about service traffic patterns, dated above resource utilization and performance, and real time analytics of streaming data. These data streams also provide the metrics for the formulation of control charts. It then conducts control chart based analytics by analyzing the control charts with Nelson Rules or Nelson like rules to identify abnormal events (resource and/or service events). In turn, the identified abnormal events are further analyzed using one or more analytic modes to identify potential (i.e. predict) service incidents or potential resource incidents. Based on this predictive analysis, proactive management decisions can be made to deal with the potential incidents. Implementation at the resource level could also be accomplished with autonomic or self-managed and externally managed resources. Such ultimate decisions would be referred to the enterprise monitoring and management tools which would make ultimate decisions on the potential resource and services incidents identified by the analysis of multiple resource and service events 611. Information on vendor resources and event response capabilities will be used for automated response capabilities 613 would be one of the resources it could be called on and addressing the potential service and resource incidents.

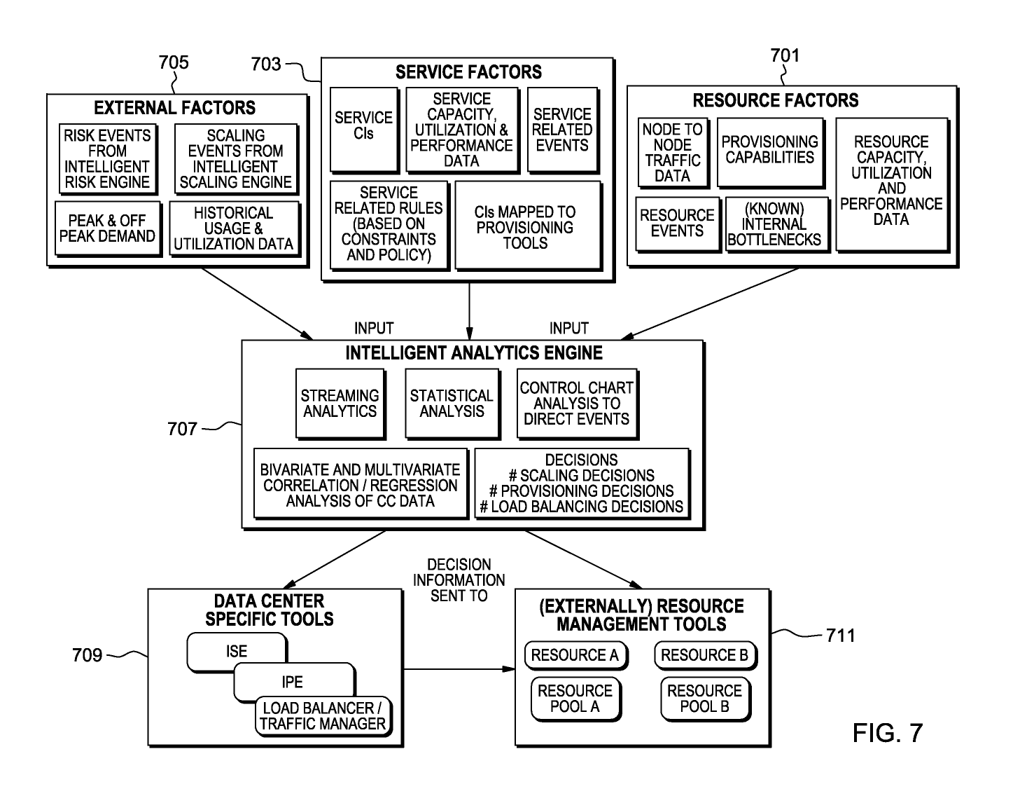

FIG. 7 depicts an architectural diagram of an autonomic computing system that incorporates an embodiment of the present invention. An autonomic system typically has four functional parts: a data collector to collect data, an analyzer that analyzes the data collected, a decision maker to determine if and what action is necessary, and an actuator to carry out actions based on the decisions made by the decision making part.

Intelligent Analytics Engine 707 receives data on the monitored metrics of the system from Resource Factors 701, Service Factor 703 and External Factors 705. In the embodiment of the invention depicted, the Intelligent Analytics Engine performs most of the functions, aside from the monitoring function, recited with respect to the flow diagram, FIG. 1. In the embodiment depicted, intelligent analytics engine 707 includes the decision making part. Decision information is then sent to the actuators, data center specific tools 709, and resource management tools 711. As part of an autonomic system sensor and monitors are built into the system in particular into service factors 703 and resource factors 701. External factors 705 may not have such self-managed sensors and monitors, but rather have monitors added to collect data on the metrics monitored. A more detailed discussion of FIG. 7 follows.

Resource Factors 701 are elements internal to the resources or configuration items that enable and support the services provided by the system. The Resource Factors include, but are not limited to, storage systems attached to mailboxes, the seek time associated with searching and finding the location of files, such as e-mails, attachments and specific data such as metadata. Metrics of these resource factors or elements are monitored and sent to Intelligent Analytics Engine 707 in real time as a continuous or discreet data stream depending on the nature of the metric being monitored. By way of example, and as previously noted, the metrics relate to the various elements of the system and include node to node data traffic, resource capabilities, resource capacity, utilization and performance data as well as information on known internal bottlenecks.

Service Factors 703 are part of and relate to the service provided over the network or system and typically constitutes that part of the network or system that of the networks user's see or with which they interface. An example is the response time to download e-mail from storage mailbox and present it to an end user when the end user clicks on the inbox button. Consequently, the overall service factors and their related metrics being provided by 703 to the intelligent analytic engine, 707, would consist of service configuration items, service capacity, utilization and performance data, service related events, configuration of items mapped tools, and service related rules based on constraint and policy.

External Factors 705 provided to Intelligent Analytics Engine 707 generally in real time are essential to the service context factors, but are extraneous to the service under consideration in that they are not part of the system or network, but can impact the system or network over which the service is provided, and thus affect the function of the service factors. Among the external factors being supplied to Intelligent Analytics Engine from External Factors are risk events from intelligent risk engines, scaling events from scaling engines, peak and off-peak demand information, and historic usage and utilization data. The External Factors also includes information regarding local weather conditions, such as the possibility of ice storms, tornadoes, or hurricanes that could damage support infrastructure causing power outages or other havoc which is supplied to the Intelligent Analytic Engine. As noted previously, this portion of such an autonomic system does not typically have built in monitoring capabilities. Thus, a monitoring function would be added for this purpose.

As noted previously, the factors or metrics being supplied by Factors 701, 703, and 705 to Intelligent Analytics Engine are received in real time and analyzed in real time. Consequently, Intelligent Analytics Engine 707 has a streaming analytics and statistical analysis capability to handle and analyze the information in real time. As the data stream is received, it formulates the data stream of metrics on the various elements, components and factors into control charts for analysis. Nelson type rules are applied to the control charts to identify abnormal service and resource events. Then the identified abnormal service and resource events are further analyzed using one or more analytic modes, such as correlation analysis, bivariate and multivariate correlation, regression analysis of control charts, as well as other analysis techniques to thereby identify potential service or resource incidents. In the embodiment of the invention depicted in FIG. 7, Intelligent Analytics Engine is configured to formulate decisions for dealing with the identified potential resource and service incidents. Such decisions on a course of action can include scaling decisions, provisioning decisions, and load balancing decisions. This information would then be forwarded to appropriate Data Center Specific Tools 709 and/or Resource Management Tools 711 for appropriate action to deal with the potential service or resource incidents and thereby prevent the identified potential incidents from occurring and disrupting service on the system.

The decision information generated as a result of identification and analysis of the resource and service events and prediction of potential service incidents and potential resource incidents can result in activation of Data Center specific tools 709, such as an intelligent scaling engine (ISE), an intelligent provisioning engine (IPE) and/or load balancer/traffic manager tools to address and prevent the identified potential service incident or resource incident from occurring. The decision information can also activate resource management tools 711 to deal with and activate externally managed management tools 711. A multitude of actions can be taken depending on the identified potential incident. For example, if the potential incident indicates that a memory or storage device is about to fail and thus result in a service incident, the action taken could include quarantining the device and backing up its contents to another storage or memory device.

While the particular embodiments of the present invention have been described herein for purposes of illustration, many modifications and changes will become apparent to those skilled in the art. Also, the descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvements over technologies found in the marketplace, or to enable others of ordinary skill in the art to understand the embodiments disclosed herein.

What is claimed is:

1. A method for controlling service functionality in a distributed network comprising:
monitoring metrics of a plurality of network factors;
formulating a control chart for each metric monitored of the network factors;
detecting abnormal events by applying Nelson Rules to the control charts;
predicting if an abnormal event indicates a potential incident by analyzing the abnormal events with a predetermined analytic mode; and
controlling service functionality of the distributed network based on the information regarding detected abnormal events and potential incidents.

2. The method of claim 1 wherein the step of detecting an abnormal event comprises the further step of determining if it is an abnormal resource event or an abnormal service event and the step of predicting if an abnormal event indicates a potential incident comprises the further step of determining if it is a potential resource incident or a potential service incident.

3. The method of claim 1 wherein the step of analyzing with a predetermined analytic mode includes analyzing by one or more of the following analytic modes: correlation analysis, multivariate analysis, and time series analysis.

4. The method of claim 2 comprising the further step of using at least one detected abnormal resource event as an independent variable and using at least one abnormal service level event as a dependent variable in a multivariate analysis to identify a potential resource incident or a potential service incident.

5. The method of claim 2 comprising the further step of using at least one potential resource incident as an independent variable and using the at least one potential service incident as a dependent variable in a multivariate analysis of historical data on incidents to identify additional potential resource incidents or potential service incidents.

6. The method of claim 1 wherein the step of controlling service functionality includes taking one or more of the following actions with respect to the network: scaling, reconfiguring, load balancing, managing traffic, and fault management.

7. The method of claim 1 wherein the step of analyzing with an analytic mode comprises:
a. determining if an identified abnormal event is an abnormal resource event or an abnormal service event;
b. selecting one of the following analytic modes to identify potential incidents: i) correlation analysis, ii) multivariate analysis, or iii) time series analysis;
c. selecting independent and dependent variables to conduct the analysis with the selected analytic mode;
d. selecting criteria for identifying potential incidents;
e. applying the selected analytic mode based on the selected variables and the selected criteria to identify potential incidents; and
f. determining if an identified potential incident is a potential resource incident or a potential service incident.

8. A computer program product for controlling service functionality of a distributed network, said computer product comprising:
a computer readable storage medium;
first program instructions for monitoring metrics of a plurality of distributed network factors;
second program instructions for formulating control charts based on the metrics monitored;
third program instructions for detecting abnormal events by applying Nelson Rules to said control charts;
fourth program instructions for predicting if any abnormal event indicates a potential incident by analyzing said abnormal events with a predetermined analytic mode;
fifth program instructions for controlling service functionality of the network based on information regarding said detected events and said potential incidents; and
wherein said first, second, third, fourth and fifth program instructions are stored on said computer readable storage medium.

9. The computer program product of claim 8 wherein the program instructions to detect an abnormal event includes the instructions to determine if it is an abnormal resource event or an abnormal service event, and wherein the program instructions to predict abnormal event is an incident include instructions to determine if it is an abnormal resource incident or an abnormal service incident.

10. The computer program product of claim 8 wherein the step of analyzing with a predetermined analytic mode includes analyzing by one or more of the following analytic modes: correlation analysis, multivariate analysis, and time series analysis of control chart data.

11. The computer program of claim 9 comprising the further instruction of using at least one detected abnormal resource event as an independent variable and using the at least one abnormal service level event as a dependent variable in a multivariate analysis to identify potential resource incidents or potential service incidents.

12. The computer program product of claim 9 comprising the further step of using at least one potential resource incident as an independent variable and using the at least one potential service incident as a dependent variable in a multivariate analysis of historical data on incidents to identify additional potential resource incidents or potential service incidents.

13. The computer program product of claim 8 wherein the step of controlling service functionality includes taking one or more of the following actions with respect to the network: scaling, reconfiguring, load balancing, managing traffic, and fault management.

14. The computer program product of claim 8 wherein the program instructions of analyzing with a predetermined analytic mode includes:
sixth program instructions for determining if an identified abnormal event is an abnormal resource event or an abnormal service event;
seventh program instructions for selecting one of the following analytic modes to identify potential incidents: i) correlation analysis, ii) multivariate analysis, or iii) time series analysis;
eight program instructions for selecting independent and dependent variables to conduct the analysis with the selected analytic mode;
ninth program instructions for selecting criteria for identifying potential incidents;
tenth program instructions for applying the selected analytic mode based on the selected variables and the selected criteria to identify potential incidents;
eleventh program instructions for determining if an identified potential incident is a potential resource incident or a potential service incident; and
wherein said fifth, sixth, seventh, eighth, ninth, tenth and eleventh program instructions are also stored on said computer readable storage medium.

15. An engine for control of service functionality of a distributed network, comprising:
a computer readable storage medium;
a processor operatively coupled to said computer readable storage medium and also operatively coupled to a plurality of external factor monitors, a plurality of service factor monitors, and a plurality of resource factor monitors in the distributed network;
an intelligent analytics engine operatively connected to said processor and said computer readable storage medium, said intelligent analytic engine having program instructions for formulating into control charts, metrics gathered from said plurality of external factor monitors, said plurality of service factor monitors, and said plurality of resource factor monitors;
said intelligent analytics engine having program instructions for detecting abnormal service events and abnormal resource events by applying Nelson style rules to said control charts;
said intelligent analytics engine having program instructions for identifying potential resource incidents and potential service incidents by analyzing said detected abnormal resource events and said detected abnormal service events with a predetermined analytic mode;
said intelligent analytics engine having program instructions for sending information on said detected service events, said detected resource events, said identified potential resource incidents, and said identified potential service incidents to a network control center to thereby aid in controlling resource and service functionality of the distributed network; and
wherein all of said program instructions are stored on said computer readable storage medium.

16. The engine of claim 15 wherein analyzing with a predetermined analytic mode includes analyzing by one or more of the following analytic modes:
correlation analysis, multivariate analysis, and time series analysis of control chart data.

17. The engine of claim 15 comprising the further instructions of using said detected abnormal resource events as an independent variables and using said detected abnormal service level events as a dependent variables in a multivariate analysis to identify a potential resource incident or a potential service incident.

18. The engine of claim 15 comprising the further step of using said potential resource incidents as an independent variables and using said potential service incidents as a dependent variables in a multivariate analysis of historical data on incidents to identify additional potential resource incidents or potential service incidents.

19. The engine of claim 15 wherein controlling service functionality at a network control center includes taking one or more of the following actions with respect to the network: scaling, reconfiguring, load balancing, managing traffic, and fault management.

20. The engine of claim 15 wherein the program instructions of analyzing with a predetermined analytic mode includes:
program instructions for selecting one of the following analytic modes to identify potential incidents: i) correlation analysis, ii) multivariate analysis, or iii) time series analysis;
program instructions for selecting independent and dependent variables to conduct the analysis with the selected analytic mode;
program instructions for selecting criteria for identifying potential incidents;
program instructions for applying the selected analytic mode based on the selected variables and the selected criteria to identify potential incidents;
program instructions for determining if an identified potential incident is a potential resource incident or a potential service incident; and
wherein all said program instructions are also stored on said computer readable storage medium.
